(19) United States
(12) Patent Application Publication
(10) Pub. No.: US 2023/0323548 A1
(43) Pub. Date: Oct. 12, 2023

(54) ELECTRODE FOR GAS EVOLUTION IN ELECTROLYTIC PROCESSES

(71) Applicant: INDUSTRIE DE NORA S.P.A., Milan (IT)

(72) Inventors: Riccardo MARINA, Bergamo (IT); DJ Donn MATIENZO, Milan (IT); Chiara DI BARI, Milan (IT); Francesco PINO, Milan (IT); Emanuele INSTULI, Milan (IT)

(21) Appl. No.: 18/042,500

(22) PCT Filed: Aug. 27, 2021
(86) PCT No.: PCT/EP2021/073783

§ 371 Date: Feb. 22, 2023

(30) Foreign Application Priority Data
Aug. 28, 2020 (IT) 102020000020575

(51) Int. Cl. C25B 11/077; C25B 11/061; C23C 18/12; C23C 4/08

(52) U.S. Cl. CPC C25B 11/077; C25B 11/061; C23C 18/1295; C23C 4/08; C23C 18/1216

(57) ABSTRACT

An electrode for gas evolution in electrolytic processes and a method for the production of such an electrode, the electrode having a metal substrate and a coating formed on the substrate, wherein the coating has at least a highly porous catalytic outer layer containing nickel oxide and nickel hydroxide, the porous outer layer having a surface area of at least 40 m²/g (BET). The catalytic layer is prepared from a Ni oxide/V oxide initial coating with subsequent leaching of V.

### FIELD OF THE INVENTION

The present invention concerns an electrode for gas evolution in electrolytic processes comprising a nickel substrate and a nickel-based catalytic coating. Such electrodes can particularly be employed as anodes in an electrochemical cell, for instance as an oxygen-evolving anode in alkaline water electrolysis.

### BACKGROUND OF THE INVENTION

Alkaline water electrolysis is typically carried out in electrochemical cells where an anodic and a cathodic compartment are divided by a suitable separator such as a diaphragm or a membrane. An aqueous alkaline solution at a pH higher than 7, for instance an aqueous KOH solution, is supplied to the cell and an electrical current flow is established between electrodes in the cathodic and anodic compartment, respectively, i.e. between cathode and anode, at a potential difference (cell voltage) with a typical range of 1.8 to 2.4 V. Under these conditions, water is split into its constituents so that gaseous hydrogen evolves at the cathode and gaseous oxygen evolves at the anode. The gaseous products are removed from the cell so that the cell can be operated in a continuous fashion. The anodic oxygen evolution reaction can be summarized as follows:

4 OH⁻→O₂+2 H₂O+4e⁻

Alkaline water electrolysis is typically carried out in a temperature range from 40 to 90° C. Alkaline water electrolysis is a promising technology in the field of energy storage, particularly storage of energy from fluctuating renewable energy sources such as solar and wind energy.

In this respect, it is particularly important to reduce the cost of the technology in terms of less expensive equipment, such as less expensive electrodes, but also in terms of efficiency of the overall process. One important aspect of cell efficiency concerns the required cell voltage in order to effectively generate water electrolysis. The overall cell voltage is essentially governed by the reversible voltage, i.e. the thermodynamic contribution to the overall reaction, voltage losses due to Ohmic resistances in the system, the hydrogen overpotential relating to the kinetics of the hydrogen evolution reaction at the cathode and the oxygen overpotential relating to the kinetics of the oxygen evolution reaction at the anode.

The oxygen evolution reaction has a sluggish kinetic, which is the cause of the high overpotential of the anode. The result is the increase of the operating cell voltage and the difficulty of the large-scale commercialization of the technology.

In addition, another key feature of the electrode is the resistance to unprotected shutdowns. In fact, during typical operation of an electrolysis plant made of a stack of single electrochemical cells, it is often requested to stop the power supply due to technical problems maintenance, causing an inversion of polarity harmful for the electrodes. Such inversion is usually avoided using an external polarisation system (or polarizer) which maintains the electrical current flow in the desired direction. This ancillary component circumvents the potential electrode degradation caused by metal dissolution or electrode corrosion but increase the investment cost of the system.

In prior art, preferred anodes/anodic catalysts for alkaline water electrolysis include bare nickel (Ni) electrodes, Raney nickel (Ni+Al) electrodes and electrodes having iridium (Ir) oxide-based catalytic coatings.

A bare nickel electrode is formed by a nickel substrate only, such as a Ni mesh, which can easily be manufactured at low cost but which exhibits a high oxygen overpotential resulting in sluggish kinetics.

Raney nickel electrodes are manufactured by thin film deposition of the catalytic powder of Ni+Al by plasma spray technique. At the industrial level, plasma spray technique is not often used for catalytic coatings due to the high cost of production and health and safety hazards associated with the technique, such as noise, explosiveness, intense flame at temperatures above 3000° C., fumes, etc. Moreover, the Raney nickel manufacturing process involves an activation process which is accomplished by leaching of aluminium from the catalytic coating, leaving almost pure nickel on the surface and increasing the surface area substantially. During the reaction of Al dissolution, H₂ is produced which constitutes a problem during the manufacturing process due to the abrupt exothermic reaction. Another technical problem of Raney nickel deposited via plasma spray is the resulting rather indented morphology of the coating. In a zero-gap cell, where the electrode is in contact with the membrane, the sharp indented surface may cause damage to the membrane.

Electrodes with iridium-based catalytic coatings are produced by thermal decomposition which is a well-established technology providing less hazards. However, iridium used in these electrodes is one of the least abundant noble metals in the earth's crust resulting not only in a high price but also in difficulties purchasing bulk quantities for industrial-scale manufacturing processes (for instance, gold is 40 times more abundant and platinum is 10 times more abundant than iridium). Moreover, Iridium-based coatings are typically multilayer coatings resulting in costly manufacturing processes. The multilayer catalytic coatings comprise, for instance, an interlayer directly applied on a Ni substrate, an active layer applied to the interlayer and an iridium oxide outer layer. These multilayer compositions typically exhibit a low resistance to unprotected shutdowns because Ir and other non Ni metals present in their formulations, such as Co, may dissolve into the electrolyte solution during inversion of polarity.

CN 110394180 A describes an electrode having a nickel substrate and a surface comprising nickel hydroxide and nickel oxide which can be employed as an anode in alkaline water electrolysis. CN 110863211 A, CN 109972158 A, CN 110438528 A and CN 110952111 A describe nickel foam electrodes having an outer surface layer comprising nickel hydroxide and nickel oxide.

It is therefore an object of the present invention to provide an improved electrode which exhibits a low oxygen overvoltage in alkaline water electrolysis applications and which can more safely and more cost-effectively be produced than prior art electrodes. Moreover, it is desired that the new electrode exhibits an improved resistance to unprotected shutdowns.

### SUMMARY OF THE INVENTION

The invention is based on the concept of an electrochemically active thin film for oxygen evolution exhibiting a very high surface area. A high surface area of the coating allows a bigger quantity of electrolyte to be in contact with the catalyst and its active sites, boosting the electrochemical performances, for instance for the production of gaseous oxygen (O₂). By combining, tailoring and engineering techniques from different fields such as sol-gel synthesis and metallurgy, it has been possible to create a stable highly porous nickel oxide coating which is particularly suitable for oxygen evolution reactions.

Various aspects of the present invention are described in the appended claims.

The present invention concerns an electrode for gas evolution in electrolytic processes comprising a metal substrate and a coating formed on said substrate, wherein said coating comprises at least a catalytic porous nickel oxide outer layer which exhibits a high porosity, wherein the porous outer layer has a surface area of at least 40 m²/g determined according to BET (Brunauer, Emmett, Teller)-measurements. Due to the characteristics of the formation of the highly porous nickel oxide outer layer of the electrode of the invention, which will be explained in more detail below, two different phases of nickel oxide are present in the outer layer (i.e. different oxidation states of nickel), namely nickel oxide (NiO) and nickel hydroxide (Ni(OH)₂), respectively. The inventors surprisingly found that a highly porous nickel oxide/nickel hydroxide catalytic layer on a metal substrate exhibits a low value of oxygen overpotential so that very efficient electrolysis cells for alkaline water electrolysis can be produced with such electrodes. As a matter of course, the electrodes of the present invention can advantageously be used in any other application which benefits from low oxygen overvoltages.

The metal substrate of the electrode of the present invention is preferably a substrate selected from the group consisting of nickel-based substrates, titanium-based substrates and iron-based substrates. Nickel-based substrates include nickel substrates, nickel alloy substrates (particularly NiFe alloys and NiCo alloys and combinations thereof) and nickel oxide substrates. Iron-based substrates include iron alloys such as stainless steel. Metallic nickel substrates are particularly preferred in the context of the present invention. Like bare nickel electrodes, the electrode of the present invention benefits from the catalytic properties of nickel but without exhibiting the sluggish kinetics of bare nickel electrodes and without requiring additional noble metals or other metals for improving reaction kinetics. Consequently, the coating of the present invention is essentially free from noble metals such as iridium or other transition metals such as cobalt. “Essentially free” means that the corresponding metals are typically outside any detectable range when using, for instance, typical laboratory X-ray diffraction (XRD) techniques. The coating can, however, comprise trace amounts of vanadium (V) resulting from the preferred manufacturing technique described below, although in preferred embodiments, the electrode is also essentially free of vanadium.

In one embodiment, the catalytic outer layer consists of nickel oxide (NiO) and nickel hydroxide (Ni(OH)₂) only. Accordingly, the catalyst does not contain any scarce and expensive metals.

Preferably, the surface area of the porous outer layer is at least 60, more preferably at least 80 m²/g (BET). In certain embodiments, the surface area of the porous outer layer is comprised between 40 and 120, between 60 and 110 or between 80 and 100 m²/g (BET). Accordingly, the electrode of the invention has a catalytic layer with a highly porous nickel-based catalytic outer layer which translates in a surface area that is considerably higher than the surface area of, for instance, commercial iridium-based catalytic coatings which are typically in a range below 10 m²/g.

According to a preferred embodiment of the present invention, the porous outer layer is obtained by leaching vanadium oxide from a thermally treated gel-like precursor coating containing nickel salts and vanadium salts. Accordingly, the present invention combines two techniques for obtaining a porous nickel oxide catalytic coating, namely sol-gel synthesis combined with thermal formation of nickel oxide (NiO) and vanadium oxide (VO). Further, employing the concept of removal of a sacrificial metal by selective leaching from metallurgy, vanadium oxide is removed leading to a further increase in surface area. Accordingly, the oxide coating is produced by thermal decomposition which is a well-developed process which easily translates into large-scale production. Moreover, thermal decomposition techniques are easily tunable to a large variety of nickel substrates, independently from geometry or size of the substrate. In addition, the highly porous nickel oxide coating is obtained from nickel and vanadium only, i.e. highly abundant metals in the earth's crust and considerably less expensive than noble metals such as iridium. Due to the high abundancy, bulk purchases necessary for industrial-scale production are easily accomplished. Moreover, the leaching step necessary to remove vanadium oxide from the coating is less challenging than the leaching step of Raney nickel production, because leaching of vanadium does not produce hydrogen gas during its dissolution, thus avoiding associative health and safety hazards. Finally, the morphology of the coating produced according to the method of the present invention is substantially flat thus avoiding damages of membranes in zero-gap electrolysis cells.

In a preferred embodiment, the coating comprises a nickel-based interlayer deposited between the nickel substrate and the catalytic porous outer layer. Preferably, the nickel-based interlayer consists of metallic nickel or a combination of metallic nickel and nickel oxide. The nickel/nickel oxide interlayer preferably has a porosity less than about 1 m²/g.

It has surprisingly been found that the catalytic coating, when applied on the nickel/nickel oxide interlayer described above, can withstand unprotected shutdowns imposed by the operations and maintenance of the electrolysis plant without requiring additional, costly polarization units.

The nickel interlayer has a preferred nickel loading in a range from 100 to 3000 g/m² referred to the metal elements, even more preferably from 200 to 800 g/m².

The interlayer is usually denser than the outer catalytic layer.

In one embodiment, the interlayer has an electric double layer capacitance in a range of from about 1.0 to about 10.0 mF/g.

The interlayer can be obtained using a variety of techniques, such as thermal spraying techniques, laser cladding or electroplating. In a preferred embodiment, the thermal spraying techniques are chosen from the group consisting of wire-arc spraying and plasma spraying.

In one embodiment, the porous outer layer has a thickness in the range of 5 to 40 micrometre (μm), preferably in the range of 10-20 μm. The porous outer layer has a preferred nickel loading in a range from 5 to 50 g/m² referred to the metal element. When applied directly to the nickel substrate, the catalytic coating is particularly useful for low current density applications (e.g. in the range of 1 kA/m² or up to several kA/m²). For these applications, a preferred nickel loading is typically in the range of 6-15 g/m². If the porous outer layer is applied on a nickel interlayer, these embodiments can be used for high current density applications (e.g. at 10 kA/m² and more) so that higher nickel loadings, typically in the range of 15-25 g/m² and more, are preferred.

The coating consisting of porous outer layer and interlayer has a thickness in a range from 30 to 300 μm, preferably approximately 50 μm.

The coating consisting of porous outer layer and, optionally, interlayer may be applied on one or on both sides of the metal substrate of electrode, as customary in the field and depending on the cell configuration and on the electrode placement inside the cell.

Preferably, the metal substrate is nickel-based, and even more preferably is a nickel mesh which can be employed in a variety of configurations regarding mesh thickness and mesh geometry. Preferred mesh thicknesses are in the range of 0.2 to 1 mm, preferably around 0.5 mm. Typical mesh openings are rhombic openings having a long width in range of 2 to 10 mm and a short width in the range of 1 to 5 mm.

Due to its low value of oxygen overvoltage, the electrode of the present invention is preferably used as an anode for oxygen evolution, particularly as an anode in an electrolysis cell for alkaline water electrolysis. Therefore, the present invention is also directed to an electrolysis cell for electrochemical processes, especially for alkaline water electrolysis, comprising an anode for oxygen evolution and a cathode, wherein the anode is an electrode as defined above.

The present invention is also directed to a method for the production of an electrode as defined above, wherein the method comprises the following steps:
a) application to a metal substrate of a coating solution comprising a nickel salt, a vanadium salt and a gelling agent,
b) subsequent drying at a temperature in the range from 80-150° C., preferably for 20-40 minutes, typically for 30 minutes,
c) followed by calcination at a temperature in the range from 300-500° C., typically at 400° C., preferably for 5 to 15 minutes, typically for 10 minutes, for oxidation of the metal salts into metal oxides;
d) repetition of steps a) to c) until a coating having a desired specific load of nickel is obtained (it is understood that when the desired load is reached in a single execution of steps a) to c), no repetition is required);
e) final thermal treatment (second calcination) at a temperature in the range from 300-500° C., typically at 400° C., for preferably 1 to 4 hours, typically for 2 hours;
f) leaching of vanadium from said coating in an alkaline bath creating a highly porous catalytic outer layer comprising nickel oxide and nickel hydroxide.

According to the present invention, the nickel oxide/nickel hydroxide outer catalytic layer can be created in a series of layers in order to precisely tailor the desired nickel load. As only one coating composition is used, the manufacturing of the coated electrode is faster and leaner than prior art methods and therefore less expensive. Moreover, the oxide coating is produced by thermal decomposition which is a well-developed process on industrial-scale coating production.

The application of the coating solution to the substrate in step a) is preferably accomplished by brushing or spraying techniques and the coating solution is preferably aqueous.

The combination of organic and inorganic chemical precursors in the coating solution creates a macroporous gel structure, with the metal salts embedded in it. In the drying step, the solvent is dried out. During the following thermal treatment at temperatures able to calcinate the precursor metal salts, the dissolved metals become oxides, while the other components evaporate or are burnt away, leaving a metal oxide porous structure. The coating solution preferably comprises a solvent made from water and/or an alcohol, such as ethanol, and an acid, such as hydrochloric acid. Suitable additives acting as a gelling agent include ethylene glycol and citric acid. In one embodiment, the solvent and gelling agent for the sol-gel approach comprises ethanol or water or an ethanol/water mixture and hydrochloric acid as a solvent, ethylene glycol and citric acid in a ratio 14:4,5:1 in number of moles (i.e. solvent:ethylene glycol:citric acid). In addition to its function in the sol-gel synthesis, ethylene glycol creates a ‘dry mud’ morphology after vaporisation during the thermal treatment: Ethylene glycol is heated above its decomposition temperature and is burnt away as CO₂ leaving a particularly open structure compared to traditional purely inorganic coating solutions for dimensionally stable anode manufacturing.

The nickel salts are preferably nickel halides, for example nickel chloride and the vanadium salts are preferably vanadium halides, for example vanadium chloride.

After the application on the metal substrate, the coating is composed by two separated crystal phases: nickel oxide (NiO) and vanadium oxide (VO) and the vanadium oxide is removed by leaching with an alkaline solution (e.g. 6M KOH at 80° C.) in order to obtain an activated microporous Ni oxide structure (mixed phases of NiO and Ni(OH)₂). Accordingly, step f) is preferably carried out in an aqueous alkaline hydroxide solution, for instance in a 6M NaOH or 6M KOH solution at a temperature between 60 and 100° C., typically at a temperature of 80° C. for a time period in the range from 12 and 36 hours, typically for a time period of 24 hours.

It has been found that the ratio of nickel oxide/nickel hydroxide can be tailored by selecting a suitable ratio of nickel/vanadium in the coating solution. Preferably, the atomic ratio of Ni/V in the coating solution is around 100/100 leading to atomic percentages of around 25-15 atomic % NiO and around 75-85 atomic % Ni(OH)₂ in the final outer catalytic layer. Generally, the atomic percentage of Ni(OH)₂ in the catalytic coating decreases with decreasing V content in the coating solution.

In the context of the present invention, the catalytic highly porous (HP) nickel oxide outer layer obtained from thermal decomposition of a dried gel-like coating comprising nickel salts and vanadium salts with subsequent leaching of vanadium oxide is denoted as HP—NiOₓ.

In a preferred embodiment, an intermediate step a0) is performed before step a) where a nickel or nickel/nickel oxide interlayer is applied onto the metal substrate before step a), preferably via thermal spraying, laser cladding or electroplating, and so that the interlayer exhibits a porosity of less than about 1 m²/g (BET). This results in an electrode having a higher resistance against unprotected shutdowns, especially at high current densities.

Preferably, step a0) comprises plasma spraying nickel powder on the metal substrate in ambient air. In one embodiment, the nickel powder that is plasma sprayed onto the substrate has a mean particle size of from about 10 μm to about 150 μm, preferably from about 45 μm to about 90 μm.

### BRIEF DESCRIPTION OF THE DRAWINGS

The invention will now be described in connection with certain preferred embodiments and corresponding figures in more detail.

In the drawings,

FIG. 1 depicts SEM-photographs of the surface and of a cross-sectional image of the catalytic outer layer of the electrode of example 2 without nickel interlayer;

FIG. 2 depicts the results of a BET surface area measurement of the outer surface of the electrode of example 2;

FIG. 3 depicts a diffraction pattern of the electrode of example 2;

FIG. 4 shows the results of an accelerated life time test of an electrode of example 2 compared with prior art electrodes;

FIG. 5 depicts SEM-photographs of the surface and of a cross-sectional image of the catalytic outer layer of the electrode of example 3 with nickel interlayer;

FIG. 6 shows the results of shutdown tests of an electrode of example 3 compared with a bare nickel electrode of prior art; and

FIG. 7 shows the results of shutdown tests of an electrode of example 3 compared with an iridium-based electrode of prior art.

### DETAILED DESCRIPTION OF PREFERRED EMBODIMENTS

### Example 1: Preparation of Coating Solution

For preparing one litre (l) of coating solution, 0.4 l of demineralized water, 0.4 l of ethylene glycol and 0.2 l of 37% hydrochloric acid were mixed in a flask and stirred for 10 minutes. 300 g of VCl₃ were added to the solution and dissolved under stirring for 30 minutes. Subsequently, 450 g NiCl₂ 6H₂O were added to the solution and dissolved under stirring for 30 minutes. 300 g of citric acid were added to the solution and dissolved under continuous stirring for 45 minutes.

### Example 2: Preparation of an HP—NiOₓ Coated Nickel Mesh Electrode without Interlayer

For preparing 1 m² of coated mesh, a nickel rhombic mesh with a 0.5 mm thickness was sandblasted and etched in a hydrochloric acid solution. 4 ml of the coating solution of Example 1 were deposited by brushing on each side of the mesh, dried at 130° C. for 30 minutes and calcinated at 400° C. for 10 minutes resulting in a nickel loading for one cycle of 1 g/m² projected area. The deposition, drying and calcination steps were repeated for a total of 10 cycles to obtain a final nickel loading of 10 g/m² projected area. Subsequently, the coated electrode was post-baked at 400° C. for 2 hours. Finally, the electrode was leached in an alkaline NaOH bath for vanadium removal at a temperature of 80° C. for a total time of 24 hours.

### Example 3: Preparation of a HP—NiOₓ Coated Nickel Mesh Electrode with Nickel Interlayer

A nickel rhombic mesh, with a 0.5 mm thickness, was plasma sprayed with 99.9% purity nickel powder with a particle size of 45±10 μm (Fe<0.5, 0<0.4, C<0.02, S<0.01 in ambient air on both sides in an amount of 4.8±0.5 g/dm² and with a target thickness of 50 μm on each side). Afterwards, the sprayed wire mesh was heated in an oven at 350° C. for 15 minutes in air. The plasma-sprayed woven mesh was allowed to cool and then was coated with a precursor composition, by means of a brush, in a series of coating, heating and cooling steps. For preparing 1 m² of coated mesh provided with the nickel interlayer, 14 ml of the coating solution of Example 1 were deposited by brushing on each side of the mesh, dried at 130° C. for 30 minutes and calcinated at 400° C. for 10 minutes resulting in a nickel loading for one cycle of 3 g/m² projected area. The deposition, drying and calcination steps were repeated for a total of 7 cycles to obtain a final nickel loading of 21 g/m² projected area. Subsequently, the coated electrode was post-baked at 400° C. for 2 hours. Finally, the electrode was leached in an alkaline NaOH bath for vanadium removal at a temperature of 80° C. for a total time of 24 hours.

### Counterexample 4

A nickel rhombic mesh with a 0.5 mm thickness comprising a three-layer coating made of a LiNiO base layer, a NiCoOₓ interlayer and a IrOₓ top layer was obtained by sequentially applying via brushing and thermally decomposing each corresponding precursor solution onto the mesh substrate (or the respective underlying layer).

### Counterexample 5

A nickel rhombic mesh with a 0.5 mm thickness comprising a two-layer coating made of a LiNiO base layer, a LiNiIrOₓ top layer was obtained by sequentially applying via brushing and thermally decomposing each corresponding precursor solution onto the mesh substrate (or the respective previous layer).

The electrodes of Examples 2 and 3 according to the present invention have been characterized using different techniques and compared with Counterexamples 4 and 5.

A. Characterization of the Electrode of Example 2 (Electrode with HP—NiOₓ Catalytic Layer but without Nickel Interlayer)

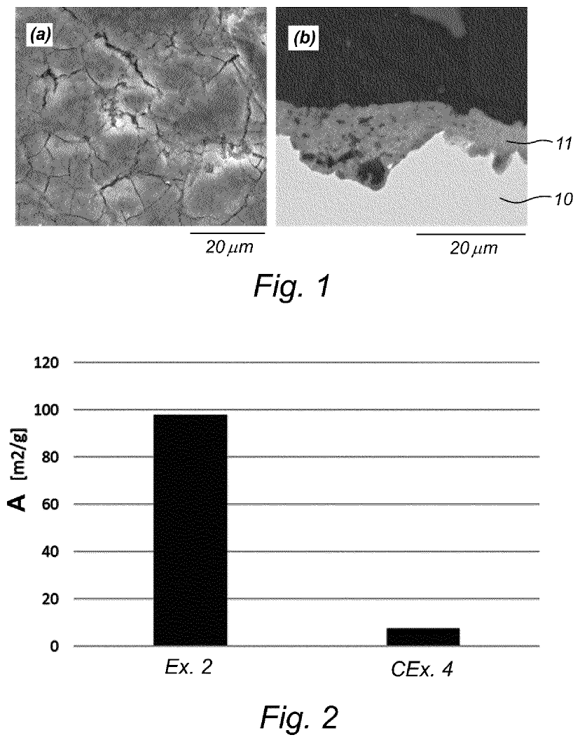

A.1 Scanning Electron Microscopy (SEM) was employed to evaluate the morphology of the coating both on surface and cross-section, respectively. The analysis has been performed on fresh and used samples to qualitatively estimate properties as stability, adhesion and consumption of the coating. FIG. 1 shows SEM images of surface view (a) and of a cross-sectional view (b) of an electrode of the present invention prepared according to Example 2. The morphological surface analysis shows the flat “dry mud” morphology of the HPNiOₓ coating while the cross section shows the porosity of the coating. In addition, in the cross section it is possible to see the phase homogeneity of the coating. The images, especially the cross-sectional view (b) show that the bulk nickel substrate 10 exhibits a certain roughness after sandblasting and etching which benefits the adhesion/anchoring of the catalytic porous outer layer 11 on the substrate. However, the outer surface of the catalytic outer layer 11 applied according to the method of the present invention is smooth, thus preventing damage to a delicate membrane when assembled into an electrolysis cell.

A.2 A Corrected Impedance Single Electrode Potential (CISEP) test was employed to characterize the electrochemical performance of the electrode of the invention compared to prior art anodes used in alkaline water electrolysis. To determine the oxygen overvoltage of the electrode of the present invention, it has been tested as an anode in a three-electrode beaker-cell. The testing conditions are summarized in Table 1.

TABLE 1

| | |
|---|---|
| Electrolyte | 25 wt % KOH in ultrapure H₂O (1.5 l) |
| Temperature | 80° C. |
| Cathode | Nickel mesh (projected area 12 cm²) |
| Working anode | 1 cm² projected area |
| electrolysis area | |
| Reference electrode | Saturated Calomel Electrode (SCE) |

At first, the sample undergoes 2 hours of pre-electrolysis (conditioning) at 10 kA/m² to stabilise the oxygen overvoltage (OOV). Then, several chronopotentiometry steps are applied to the sample. Final output of the CISEP test is the average of the three steps performed at 10 kA/m², corrected by the resistance of the electrolyte.

Table 2 summarizes a comparison between a bare nickel anode (Base Ni), the iridium-based anode of Counterexample 4 (CEx 4), a Raney nickel anode (Ni Raney), and the electrode of Example 2 (HP—NiOₓ):

TABLE 2

| | OOV vs NHE [mV] |
|---|---|
| | @ 10 kA/m² |
| Bare Ni | 340 |
| CEx 4 | 260 |
| Ni Raney | 240 |
| HP-NiOₓ | 200 |

The energetic saving (140 mV lower 00V than Bare Ni) obtainable with the anode of the present invention solves the problem of the high operational costs given by the sluggish kinetic of the anodic reaction of an uncoated nickel mesh without involving costly noble metals or hazardous manufacturing processes.

A.3 BET measurements were performed to determine the surface area of the electrode of Example 2 as compared to the electrode of Counterexample 5 (CEx 5) which is also suitable for alkaline water electrolysis. The results shown in FIG. 2 indicate that the electrode of Example 2 has a surface area which is considerably higher than the prior art electrode.

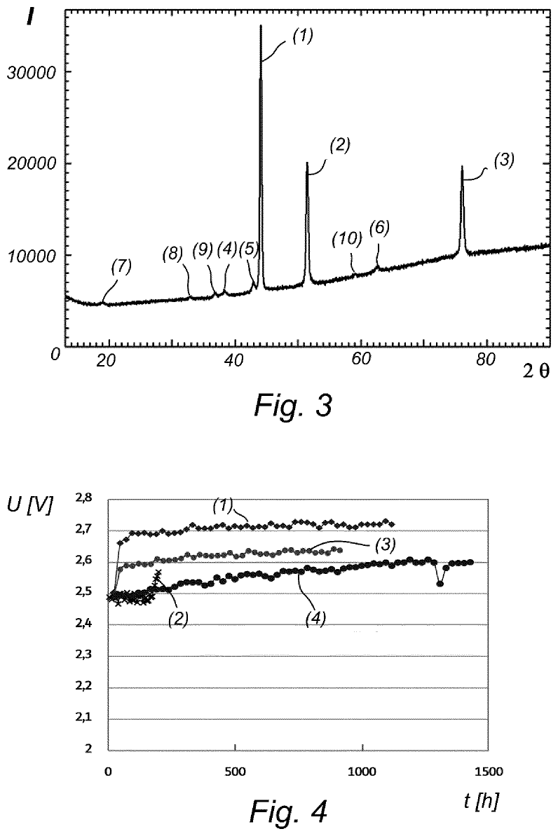

A.4 X-Ray diffraction (XRD) techniques were used to evaluate the type of formed oxides and their crystalline structure. A typical diffraction pattern resulting from an electrode according to Example 2 is shown in FIG. 3. The x-axis denotes the diffraction angle 2θ and the y-axis denotes the diffraction intensity in arbitrary units (for instance in counts per scan). Strong peaks (1), (2) and (3) correspond to the Ni substrate at crystallographic planes (111), (200) and (220), respectively. The weaker peaks (4), (5) and (6) correspond to a NiO phase of the highly porous catalytic outer layer at crystallographic planes (111), (200) and (220), respectively. Even weaker peaks (7), (8), (9) and (10) correspond to a Ni(OH)₂ phase of the highly porous outer catalytic coating, corresponding at crystallographic planes (001), (100), (101) and (110), respectively. Accordingly, it was determined that the catalytic coating is composed of nickel oxide (NiO) and nickel hydroxide (Ni(OH)₂). Moreover, as can be clearly taken from the diffraction pattern of FIG. 3, the highly porous catalytic coating of the present invention clearly does not contain any iridium or other rare/expensive metals. Accordingly, the cost and supply problems associated with prior art electrodes can be avoided with the electrode of the present invention.

A.5 An Accelerated Lifetime Test (ALT) was employed to estimate the lifetime of the catalytic coating. The test consists of long term electrolysis in a beaker cell with a two-electrode set up and a continued electrolysis current directly applied to them. The applied conditions are harsher compared to the one of the CISEP test and are above typical operating conditions in order to accelerate the consumption process. The conditions implied in the accelerated lifetime test are summarized in Table 3 below:

TABLE 3

| | |
|---|---|
| Electrolyte | 30 wt % KOH in ultrapure H₂O |
| Current density | 20-40 kA/m² |
| Temperature | 88° C. |
| Counter electrode | Nickel mesh |
| Working electrode | 1 cm² projected area |
| electrolysis area | |

ALT data are shown in FIG. 4. The x-axis denotes the duration of the test in hours and the y-axis denotes the cell voltage in volt. Data points (1) indicate the results for a non-coated Ni substrate showing an increase of the cell voltage from 2.5 V to 2.7 V after only a couple of hours of operation. The cell voltage remains stable at 2.7 V indicating that no further deterioration occurred. Data points (2) indicate the electrode of Example 2, which maintains a lower cell voltage of 2.5 V for approximately 250 hours until an increase of cell voltage and subsequent failure of the electrode occurred. This indicates that the electrode of Example 2 having a highly porous outer catalytic nickel oxide layer (without interlayer) has superior performance in terms of cell voltage compared to the bare nickel substrate, but is not suitable for prolonged operation under the harsh conditions of the ALT. As indicated above, the electrode of Example 2 is particularly suitable for operation under lower current densities. Data points (3) and (4) will be described in detail in connection with the characterization of the electrode of Example 3 below.

B) Characterization of the Electrode of Example 3 (Electrode with HPNiOₓ Catalytic Layer with Nickel Interlayer)

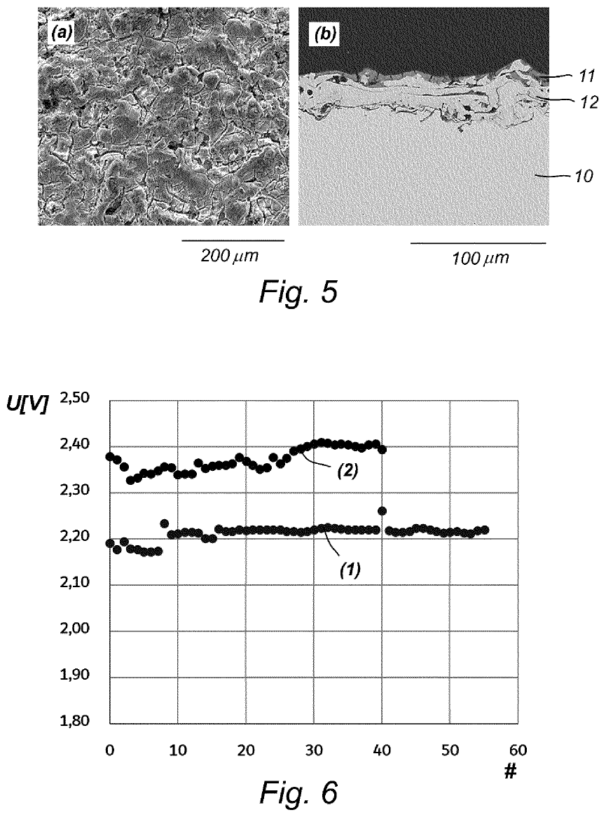

B.1 Again, Scanning Electron Microscopy (SEM) was employed to evaluate the morphology of the coating both on surface and cross-section, respectively. The analysis has also been performed on fresh and used samples to qualitatively estimate properties as stability, adhesion and consumption of the coating. FIG. 5 shows SEM images of surface (a) and of a cross-section (b) of an electrode of the present invention prepared according to Example 3 (note that the images of FIG. 5 are obtained at a lower resolution/magnification then the images of FIG. 1). Again, especially the cross-sectional view (b) shows that the while the bulk nickel substrate 10 exhibits a certain roughness after sandblasting and etching, the application of a nickel interlayer 12 by plasma spraying and a catalytic outer layer 11 using the method of the present invention result in a smooth surface.

B.2 An Accelerated Lifetime Test (ALT) as described in section A.5 above has also been conducted with the electrode of Example 3. The corresponding results are also depicted in FIG. 4. Data points (3) indicate a nickel substrate with plasma-sprayed NiO interlayer, i.e. without additional HP—NiOₓ catalytic outer layer. The mere interlayer-electrode exhibits a lower cell voltage than the bare nickel substrate, but still at least 100 mV higher than the electrode of Example 2 with a further continuous increase throughout the electrode lifetime. Data points (4) show the electrode of Example 3, i.e. a nickel substrate with a plasma-sprayed nickel interlayer and a highly porous catalytic outer layer. Electrode 3 shows the best performance in the accelerated lifetime test, having a similar low initial cell voltage of 2.5 V with a very slow continuous increase over an operational lifetime of nearly 1,500 hours.

B.3 In order to assess the resistance of the electrode of Example 3 to inversion of polarity and to estimate its' resistance to simulated plant shutdowns, shutdown tests have been performed under the operational conditions, as summarized in Table 4 below:

TABLE 4

| | |
|---|---|
| Temperature | 80° C. |
| Electrolyte | 30 wt % KOH in ultrapure H₂O |
| Current density | 10 kA/m² |

The following test protocol was carried out: After a grate-in period of 48 hours, a 6-hour shutdown was simulated by shortening the electrolysis cell with pumps staying on and letting the temperature drop to room temperature. After shutdown, electrolysis was continued for 6 hours at the operating conditions of Table 4. The shutdown cycle was repeated until failure of the electrode.

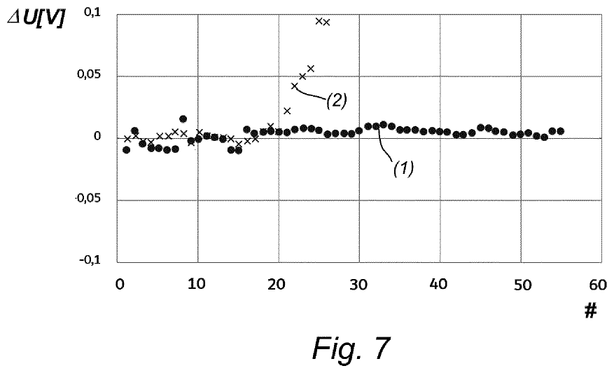

FIG. 6 shows the results of an electrode of Example 3 (data points (1)) and a bare nickel electrode (data points (2)). On the x-axis, the number of shutdowns is depicted, while the y-axis shows the cell voltage. The results indicate that the bare nickel electrode while operating at a higher cell voltage was only capable of withstanding 40 shutdowns, while the electrode of Example 3 maintained its' low cell voltage for up to 55 shutdowns. In FIG. 7, a comparison of an electrode of Example 3 (data points (1)) with the electrode of Counterexample 4 (data points (2)) is shown. On the x-axis, the number of shutdowns is depicted, while the y-axis shows the deviation from a normalized cell voltage to eliminate the constitution of cathode and separator. As can be taken from FIG. 7, the highly porous nickel oxide outer catalytic layer on a plasma-sprayed nickel interlayer can withstand more than 50 shutdowns without increase of the cell voltage. In contrast, the cell voltage of the electrode of Counterexample 4 starts to increase after 20 shutdowns already.

The preceding description is not intended to limit the invention, which may be used according to various embodiments without however deviating from the objectives and whose scope is uniquely defined by the appended claims.

In the description and in the claims of the present application, the terms “comprising”, “including” and “containing” are not intended to exclude the presence of other additional elements, components or process steps.

The discussion of documents, items, materials, devices, articles and the like is included in this description solely with the aim of providing a context for the present invention. It is not suggested or represented that any or all of these topics formed part of the prior art or formed a common general knowledge in the field relevant to the present invention before the priority date for each claim of this application.

1. An electrode for gas evolution in electrolytic processes comprising a metal substrate and a coating formed on said substrate, wherein said coating comprises at least a catalytic porous outer layer containing nickel oxide and nickel hydroxide, said porous outer layer having a surface area of at least 40 m²/g BET, wherein said porous outer layer is obtained by leaching vanadium oxide from a thermally treated gel-like precursor coating containing nickel salts and vanadium salts.

2. The electrode according to claim 1, wherein said metal substrate is a substrate selected from the group consisting of nickel-based substrates, titanium-based substrates and iron-based substrates.

3. The electrode according to claim 1, wherein said porous outer layer consists of nickel oxide and nickel hydroxide.

4. The electrode according to claim 1, wherein said porous outer layer has a surface area comprised between 40 and 120 m²/g BET.

5. (canceled)

6. The electrode according to claim 1, wherein said coating comprises an interlayer deposited between said metal substrate and said catalytic porous outer layer, the interlayer comprising nickel and/or nickel oxide.

7. The electrode according to claim 1, wherein said porous outer layer has thickness in a range from 5 to 40 μm.

8. The electrode according to claim 1, wherein said porous outer layer has a nickel loading in a range from 5 to 50 g/m² referred to the metal element.

9. The electrode according to claim 6, wherein said interlayer has a nickel loading in a range from 100 to 3000 g/m² referred to the metal element.

10. The electrode according to claim 6, wherein said interlayer has a porosity of less than about 1 m²/g BET.

11. The electrode according to claim 5, wherein said interlayer has an electric double layer capacitance, normalized by the metal loading, in a range of from about 1.0 to about 10.0 mF/g.

12. The electrode according to claim 6, wherein said coating consisting of the porous outer layer and the interlayer has an overall thickness in a range from 30 to 300 μm.

13. The electrode according to claim 6, wherein said nickel interlayer is obtained by thermal spraying, laser cladding or electroplating.

14. The electrode according to claim 13, wherein said thermal spraying, is wire-arc spraying or plasma spraying.

15. The electrode according to claim 1, wherein said substrate is a nickel mesh.

16. An electrochemical cell for electrolytic processes comprising an anode for oxygen evolution and a cathode, wherein said anode is an electrode according to claim 1.

17. A method for the production of the electrode according to claim 1 comprising the following steps:
a) applying to a metal substrate a coating solution comprising a nickel salt, a vanadium salt and a gelling agent;
b) drying at a temperature in the range of 80-150° C.;
c) calcining at a temperature in the range of 300-500° C.;
d) repeating steps a) to c) until a coating having a desired specific load of nickel is obtained;
e) finally, thermally treating at a temperature in the range from 300-500° C.; and
f) carrying out leaching of vanadium from said coating in an alkaline bath.

18. The method according to claim 17, wherein said coating solution comprises a solvent comprising water and/or an alcohol, and an acid.

19. The method according to claim 17, wherein said gelling agent comprises ethylene glycol and citric acid.

20. The method according to claim 17, wherein said nickel salts are nickel halides, and said vanadium salts are vanadium halides.

21. The method according to claim 17, wherein step f) is carried out in an aqueous alkaline hydroxide solution at a temperature in the range from 60 and 100° C. for a time period between 12 and 36 hours.

22. The method according to claim 16 further comprising an intermediate step a0) preceding step a), wherein step a0) comprises forming an interlayer of nickel and nickel oxide on the metal substrate via thermal spraying, laser cladding or electroplating, the interlayer having a porosity of less than about 1 m²/g BET.

23. The method according to claim 22 wherein the interlayer in step a0) is formed via thermal spraying by electric wire or by plasma spraying nickel powder on the metal substrate in ambient air.

24. The method according to claim 23 wherein said nickel powder is plasma sprayed onto the metal substrate and has a mean particle size of from about 10 μm to about 150 μm, or from about 45 μm to about 90 μm.
